(19) United States
(12) Patent Application Publication
(10) Pub. No.: US 2020/0078254 A1
(43) Pub. Date: Mar. 12, 2020

(54) CALIBRATION OF SENSOR FOR MEASURING USER MOVEMENT

(71) Applicants: HONDA MOTOR CO., LTD., Tokyo (JP); Kyoto University, kyoto (JP)

(72) Inventors: Hiroshi UEMATSU, Wako-shi (JP); Tae KIKUCHI, Wako-shi (JP); Yousuke NAGATA, Wako-shi (JP); Rikuto HOSAKA, Wako-shi (JP); Hidetaka NAGANO, Wako-shi (JP); Koji OHATA, Kyoto-shi (JP)

(21) Appl. No.: 16/527,722

(22) Filed: Jul. 31, 2019

(30) Foreign Application Priority Data
Sep. 7, 2018 (JP) 2018167750

(51) Int. Cl. A61H 3/00

(52) U.S. Cl. CPC A61H 3/00; A61H 2003/007; A61H 2201/165; A61H 2201/5058; A61H 2201/5007

(57) ABSTRACT

A method for calibrating an inertial measurement sensor in an accurate manner even when the sensor is attached to a patient who has difficulty in standing upright or maintaining an upright posture due to a posture or movement impairment. The method includes attaching an inertial measurement sensor (2) for detecting three-axis acceleration and three-axis angular velocity to each of a torso, a femoral part and a crural part of a user (U) for measuring a movement of the user, and having the user sit on a chair (20) in a standard posture in which the torso and the crural part of the user are substantially parallel to each other, and the femoral part is substantially orthogonal to the torso and the crural part, and calibrating the inertial measurement sensors by using outputs of the inertial measurement sensors when the user is in the standard posture as reference values.

### TECHNICAL FIELD

The present invention relates to a calibration method for a sensor for measuring movement of a user, a chair for performing this calibration method and a system for performing this calibration method in an efficient manner.

### BACKGROUND ART

A known walking assistance device that assists the walking movement of a user calculates an assisting force to be given to the user based on the difference angle between the left and right hip joints of the user (see JP5938124B1). In this walking assistance device, since the calculation of the assisting force is based on the difference angle of the hip joints, even in the case of hemiplegic walking impairment manifested by asymmetric gait of the patient, a suitable cyclic assist force can be provided to the patient.

In a known device for assisting the patient's movement to stand up, an angle measurement unit is used for acquiring the forward tilt angle of the upper torso of the patient, in addition to an electromyography unit for measuring the myoelectric value of the patient, to detect the initiation of the standing up movement of the patient from as early a stage as possible. See JP2017-164470A. In this prior art, a nine-axis sensor (IMU: Inertial Measurement Unit) capable of detecting three-axis acceleration, three-axis angular velocity, and three-axis geomagnetism is attached to the lower torso (the pelvic part) of the patient. By detecting the forward tilt angle of the patient sitting in the chair and about to stand up, instead of the actual standing up movement of the patient, the intent of the patient to stand up can be detected at an early stage.

Since the highly compact IMUs have come to be available, the use of such devices for detecting the posture and the movement of a patient is often found to be an attractive option. For instance, IMUs may be attached to suitable parts of a patient wearing a walking assistance device to measure the changes in the movement of the patient caused by the use of the walking assistance device. If desired, the measured values may be fed back to the walking assistance device. As is the case with most other sensors, calibration is required for the IMUs to produce correct measured values.

A certain calibration method has been proposed for a three-axis acceleration sensor that is to be used in a walking assistance device configured to be worn by a patient. According to this calibration method, the acceleration sensor is calibrated when a switch is operated when the patient is standing in an upright posture. See paragraphs “0021” to “0021” of JP6103280B2. The forward tilt angle of the torso of the patient can be measured as a deviation from the reference tilt angle measured when the patient was standing upright.

However, the patient may not be able to stand upright by himself or herself due to hemiplegic walking impairment or other posture or movement impairments. In such a case, IMUs attached to the patient may not be calibrated easily or correctly.

### SUMMARY OF THE INVENTION

In view of such a problem of the prior art, a primary object of the present invention is to provide a method for calibrating an inertial measurement sensor in an accurate manner even when the sensor is attached to a patient who has difficulty in standing upright or maintaining an upright posture due to a posture or movement impairment. The present invention also provides a chair that can be favorably used for implementing this calibration method, and a walking movement measurement system that allows the calibration to be performed in an accurate manner.

To achieve such an object, one aspect of the present invention provides a calibration method, comprising: attaching an inertial measurement sensor (2) to each of a torso, a femoral part and a crural part of a user (U) for measuring a movement of the user, each inertial measurement sensor being configured to measure a three-axis acceleration and a three-axis angular velocity (ST1); having the user sit on a chair (20) in a standard posture in which the torso and the crural part of the user are substantially parallel to each other, and the femoral part is substantially orthogonal to the torso and the crural part (ST2); and calibrating the inertial measurement sensors by using outputs of the inertial measurement sensors when the user is in the standard posture as reference values (ST3).

Patients suffering from various forms of motor impairment such as cerebral palsy are known to have some difficulty in maintaining an upright standing posture, but are known to be able to maintain a sitting posture in a relatively stable manner. Therefore, by calibrating the inertial measurement sensors while the user is in a sitting posture, the inertial measurement sensors can be calibrated at a high precision without causing any undue burden on the user. Typically, the reference values obtained while the user is in the sitting posture are used for determining zero points of the detection values of the inertial measurement sensors.

Preferably, the calibration method further comprises detecting the movement of the user to whom the inertial measurement sensors (2) are attached by using an optical motion capturing unit (ST7), and correcting a slope of a linear model of an output of each inertial measurement sensor according to the movement of the user detected by the optical motion capturing unit (ST8, ST9).

By thus correcting the slope of a linear model of an output of each inertial measurement sensor according to the movement of the user detected by the optical motion capturing unit, the sensitivity of each inertial measurement sensor can be correctly adjusted so that the movement of the user can be measured in a highly accurate manner.

Another aspect of the present invention provides a chair (2) for use in the calibration method, the chair including a seat (21) configured to be adjustable in height as measured from a footrest surface (26a) to a seating surface (21a) of the seat so that the femoral part of the user extends along the seating surface, a backrest (22) configured to be moveable in a fore and aft direction relative to the seat so that a back of a knee of the user adjoins a front edge of the seating surface, and a back of the user extends along a backrest surface (22a) of the backrest, and a crural guide member (25) configured to guide the crural part of the user so that a heel of the user is positioned directly under the front edge of the seating surface.

In order for the calibration of the inertial measurement sensors to be performed while the user is in a comfortable and effortless sitting posture, it is advantageous to use the specially designed chair that allows the angles of the knee joint, the pelvic joint and the ankle joint of the user to be maintained with ease.

Another aspect of the present invention provides a walking movement measurement system, comprising: a plurality of inertial measurement sensors (2) attached to a torso, a femoral part and a crural part of a user (U), respectively, for measuring a movement of the user, each inertial measurement sensor being configured to measure a three-axis acceleration and a three-axis angular velocity; a walking assistance device (10) including a pelvic frame (11) configured to be worn by a pelvic part of the user, a leg frame (12) configured to be worn by a leg part of the user, and a power unit (13) for driving the leg frame relative to the pelvic frame so as to assist a walking movement of the user; and a measurement device (4) configured to measure movements of the torso, the femoral part and the crural part of the user (U) according to outputs of the inertial measurement sensors when the walking assistance device is assisting the walking movement of the user; the measurement device being configured to calibrate the inertial measurement sensors by using, as reference values, the outputs of the inertial measurement sensors when the user is in a standard posture in which the torso and the crural part of the user are substantially parallel to each other, and the femoral part is substantially orthogonal to the torso and the crural part.

Thereby, when the walking movement of the user is assisted by the walking assistance device, the movements of the torso, the femoral part and the crural part of the user can be measured in an accurate manner by correctly calibrating the inertial measurement sensors while the user to whom the inertial measurement sensors are attached is allowed to be seated in a comfortable manner, instead of requiring the user to take an uncomfortable or difficult posture such as an upright standing posture.

Preferably, the measurement device (4) is configured to detect the movement of the user by using an optical motion capturing unit (42), and correct a slope of a linear model of an output of each inertial measurement sensor according to the movement of the user detected by the optical motion capturing unit.

Thus, the slope of a linear model of an output of each inertial measurement sensor can be corrected according to the movement of the user detected by the optical motion capturing unit. Thereby, the errors due to the variations in the properties of the inertial measurement sensors can be minimized, and the accuracy in the measurement of the movement of the user can be improved.

Preferably, the walking assistance device (10) is provided with a control unit (14) for controlling a drive force of the power unit, and the control unit is positioned on a back side of the user (U) while the inertial measurement sensor (2) attached to the torso of the user is positioned on a front side of the torso of the user.

Thereby, the inertial measurement sensor attached to the torso of the user is protected from the electromagnetic interferences that could be otherwise caused by the control unit of the walking assistance device.

Preferably, the walking movement measurement system further comprises a chair including a seat (21) configured to be adjustable in height as measured from a footrest surface (26a) to a seating surface (21a) of the seat, a backrest (22) configured to be movable in a fore and aft direction relative to the seat, and a crural guide member (25) configured to guide the crural part of the user so that a heel of the user is positioned directly under a front edge of the seating surface, and an input operation unit (5) for accepting an operation to cause the measurement device to start a calibration process of the inertial measurement sensors.

By adjusting the height of the seating surface from the footrest surface, and the fore and aft position of the backrest, the femoral part of the user is allowed to extend along the seating surface, and the back of the knee of the user is caused to adjoin the front edge of the seating surface so that the calibration of the inertial measurement sensors can be performed in an accurate manner. Upon confirming that the use is properly seated on the seat, the operator is able to command the measurement device to start the calibration process from the input operation unit. Thus, the calibration process can be performed at a precision by using a highly simple structure.

Preferably, the backrest (22) of the chair is provided with a receiving opening (37) configured to receive the pelvic frame (11) of the walking assistance device (10), and a chair-side marking (38) affixed to a part of the backrest surrounding the receiving opening, and the pelvic frame of the walking assistance device is provided with a device-side marking (39) laterally corresponding to the chair-side marking.

Thereby, the pelvic frame does not prevent the user from being seated in such a manner that the femoral part of the user extends along the seating surface, and the back of the knee of the user adjoins the front edge of the seating surface. Furthermore, the receiving opening allows the walking assistance to be placed on the user while the user is seated on the seat. This minimizes the discomfort on the part of the user which could be caused when placing the walking assistance device on the user. By aligning the chair-side marking with the device-side marking, the centering of the user with respect to the seat can be accomplished in a highly simple and accurate manner. This may also help the walking assistance device to be placed on the user at a high level of centering accuracy.

Preferably, the seat (21) is provided with a pressure sensor (27) for detecting a pressure applied to the seating surface (21a), and the measurement device (4) is provided with a lateral center determining unit (45) configured to determine if a lateral gravitational center of the user is located in a laterally central region of the seat according to an output from the pressure sensor obtained when the user sits on the seat with the standard posture.

Thereby, the lateral center determining unit of the measurement device can easily confirm that the user is seated in the center of the seat before the calibration of the inertial measurement sensors is initiated.

Preferably, the measurement device (4) further comprises a notification unit (7) for notifying an acceptable result when the lateral center determining unit has determined that the lateral gravitational center of the user is located in the laterally central region of the seat (2).

Thereby, the operator can readily confirm that the user is seated centrally on the chair before placing the walking assistance device on the user or calibrating the inertial measurement sensors.

Thus, the present invention provides a method for calibrating an inertial measurement sensor in an accurate manner even when the sensor is attached to a patient who has difficulty in standing upright or maintaining an upright posture due to a posture or movement impairment. The present invention also provides a chair that can be favorably used for implementing this calibration method, and a walking movement measurement system that allows the calibration to be performed in an accurate manner.

### BRIEF DESCRIPTION OF THE DRAWING(S)

FIG. 1 is an overall view of a walking movement measurement system according to an embodiment of the present invention;

FIG. 2 is a perspective view of a walking assistance device shown in FIG. 1;

FIG. 3 is a perspective view of a chair shown in FIG. 1;

FIG. 4 is a side view of the chair with a user sitting thereon;

FIG. 5 is a partial perspective rear view of the chair in the state shown in FIG. 4;

FIG. 6 is a partial rear view of the chair in the state shown in FIG. 4;

FIG. 7 is a block diagram of a measurement device shown in FIG. 1;

FIG. 8A is a time chart of a knee angle according to the prior art;

FIG. 8B is a time chart of a knee angle according to the embodiment of the present invention;

FIG. 9 is a graph showing a correlation between an angle of a body part of a user as detected by an inertial measurement sensor and a corresponding angle as detected by optical motion capturing; and

FIG. 10 is a flow chart showing the process of calibration according to an embodiment of the present invention.

### DESCRIPTION OF THE PREFERRED EMBODIMENT(S)

A preferred embodiment of the present invention is described in the following with reference to the appended drawings.

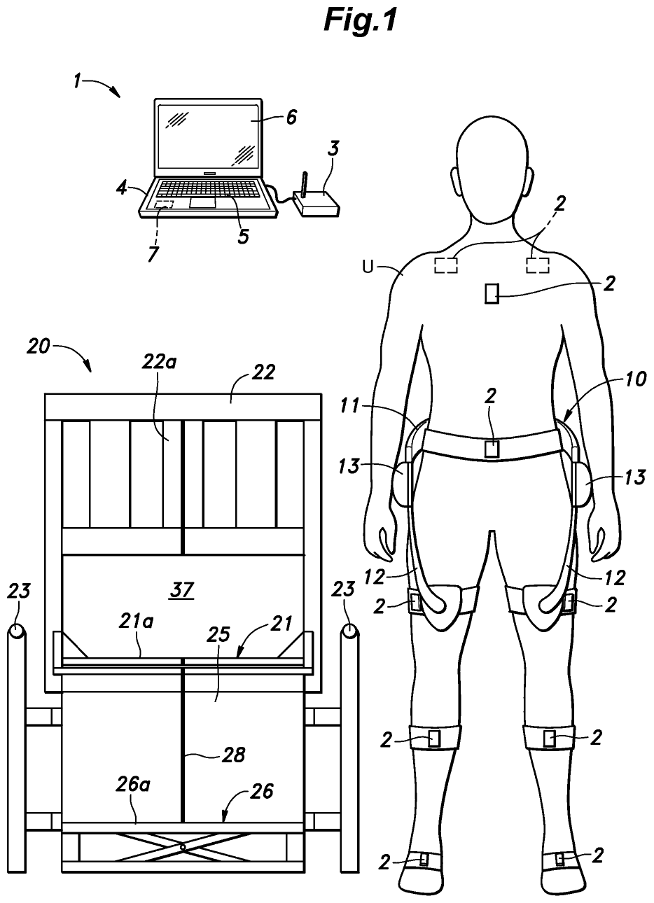

FIG. 1 is an overall schematic view showing a walking movement measurement system 1 according to an embodiment of the present invention. As shown in FIG. 1, the walking movement measurement system 1 is configured to detect the walking movement of the user U, and includes a plurality of inertial measurement sensors 2 attached to various parts of the body of the user U, and a measurement device 4 configured to acquire the outputs of the inertial measurement sensors 2 by using a wireless communication device 3. The walking movement measurement system 1 is used by an operator who intends to measure the walking movement of the user U.

Each inertial measurement sensor 2 consists of a 9-axis IMU (Inertial Measurement Unit) that detects 3-axis acceleration, 3-axis angular velocity, and 3-axis geomagnetism, and transmits the detected data from a wireless transmission unit (not shown in the drawings). The inertial measurement sensor 2 may also be a 6-axis IMU that detects 3-axis acceleration and 3-axis angular velocity. In the illustrated embodiment, a total of ten inertial measurement sensors 2 are attached to various parts of the user U including a front central part of the chest, rear parts of the left and right shoulders, a front part of the pelvic part, front parts of the left and right femoral parts, front parts of the left and right crural parts, and upper parts of the left and right feet of the user.

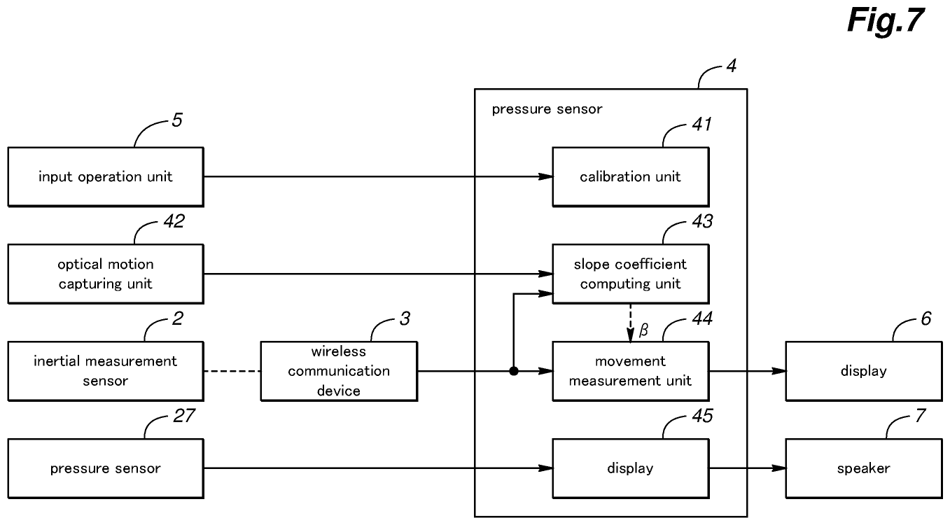

The measurement device 4 essentially consists of a personal computer provided with an electronic circuit unit including CPU, RAM, ROM, and so on. The measurement device 4 is provided with an input operation panel 5 (keyboard) for receiving an input operation, a display unit 6 for displaying information to the operator, and a speaker 7 (FIG. 7) for providing an audible warning to the operator. The measurement device 4 acquires the output from the inertial measurement sensors 2 via the wireless communication device 3, and calculates movements of various parts of the user U as numerical data from the outputs of the inertial measurement sensors 2. The data is stored and analyzed as will be described hereinafter. The CPU that constitutes the measurement device 4 is configured to read necessary data and application software from the storage device (memory) thereof, and operates under the control of the application software to perform necessary arithmetic processing.

In particular, the measurement device 4 is configured to compare the data obtained from the inertial measurement sensors 2 when the user U performs a walking movement without an aid of a walking assistance device 10 and the data obtained when the user U performs a walking movement with the aid of a walking assistance device 10.

To this end, it is desirable to attach at least five inertial measurement sensors 2 to the user, on the torso, the right and left femoral parts, and the right and left crural parts or the right and left foot regions. Thus, depending on the purpose, the inertial measurement sensors 2 may not be attached to all of the ten locations mentioned earlier.

The inertial measurement sensors 2 may not be attached to various parts of the body of the user U in a uniform manner, and the positions and/or angles of the inertial measurement sensors 2 may vary from one instance to another. Furthermore, some variations in the properties of the inertial measurement sensors 2 are inevitable. Therefore, the measurement devices 4 are required to calibrate the inertial measurement sensors 2 after they are attached to the user U. The calibration of the inertial measurement sensors 2 needs to be performed when the user has taken a prescribed posture (a standard posture), such as an upright, standing posture, for example, so that the reference points (zero points) of the values obtained from the inertial measurement sensors 2 may be established.

If the user U is suffering from certain posture or movement impairment such as hemiplegic walking impairment, the user may not be able to maintain an upright posture. Even when the user is not suffering from a posture or movement impairment, the user may still be unable to maintain an upright, immobile posture for a time period required to complete the calibration process.

Based on such considerations, in the present embodiment, a dedicated calibration chair (hereinafter simply referred to as a chair 20) is prepared in order to allow the user U to take and maintain the standard posture without requiring any undue effort for a time period required for completing the calibration process.

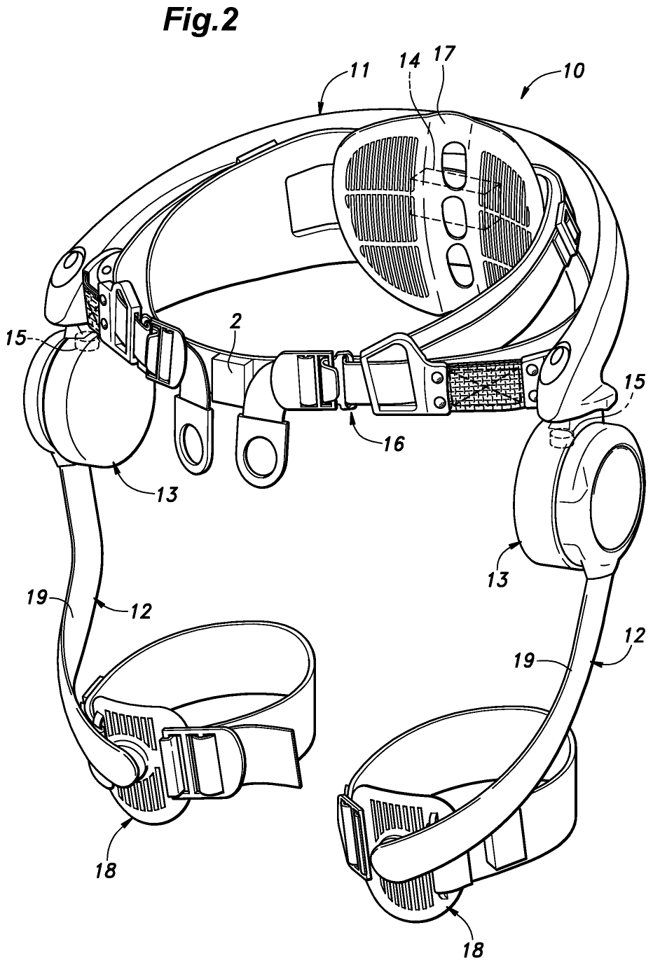

The walking assistance device 10 is described in the following with reference to FIG. 2 showing the walking assistance device 10 of FIG. 1 in an enlarged perspective view. As shown in FIG. 2, the walking assistance device 10 includes a pelvic frame 11 having a shape of letter C in plan view and configured to be worn on the hip or the waist (the pelvic part) of the user, a pair of femoral frames 12 each having a base end connected to the correspond end of the pelvic frame 11 so as to be pivotable around a rotational center line coinciding with the rotational center line of the hip joint and configured to be worn on the corresponding femoral part of the user at the free end thereof, a pair of drive units 13 for driving the respective femoral frames 12, a control unit 14 for controlling the operation of the drive units 13, a pair of angle sensors 15 for detecting the angular displacements of the respective femoral frames 12 relative to the pelvic frame 11, and a battery (not shown in the drawings) for powering the drive units 13 and the control unit 14.

The pelvic frame 11 is made of a light-weight composite material combining a rigid material such as hard resin or metal and a flexible material such as fiber, and is attached to the pelvic part of the user U by using a belt 16 connected to the pelvic frame 11. The inertial measurement sensor 2 positioned on the front part of the pelvic part of the user is attached to the belt 16. A pelvic support member 17 made of a cushioning material is attached centrally to the front surface of the pelvic frame 11 (a position opposing the lower back of the user U).

Each femoral frame 12 is provided with an arm 19 having an upper end pivotally connected to the pelvic frame 11 (or the output end of the corresponding drive unit 13), and a femoral support member 18 attached to a lower end of the arm 19 and configured to be worn on a lower femoral part of the user U. Each arm 19 is made of a high-stiffness composite material which is light in weight, and has a high mechanical strength. Each femoral support member 18 includes a highly rigid component attached to the lower end of the corresponding arm 19, and a flexible component configured to be wrapped around the lower femoral part of the user U, and connected to the rigid component. The inertial measurement sensor 2 positioned on the front part of each femoral part of the user U is attached to the femoral support member 18.

The drive units 13 are each incorporated with an electric motor, and a reduction gear unit. Each drive unit 13 drives the corresponding arm 19 at a torque that is required to provide the necessary assisting force under the control of the control unit 14 by receiving a supply of electric power from the battery. The torque provided by the drive unit 13 is thus transmitted to the femoral part of the user U via the femoral support member 18.

The angle sensors 15 consist of absolute type angle sensors attached to the respective end parts of the pelvic frame 11 on either side of the pelvic part of the user U to detect the angles (absolute angles) of the left and right femoral frames 12 with respect to the pelvic frame 11, respectively, so that the angle signals corresponding to the angles of the respective femoral frames 12 with respect to the torso of the user U are produced. The angle signals are supplied to the control unit 14.

The battery (not shown in the drawings) may be received in a recess (not shown in the drawings) formed in the pelvic frame 11, and fixedly retained therein to supply electric power to the control unit 14 and the drive unit 13. The control unit 14 is also secured to the femoral frame 12, but may also be provided separately from the walking assistance device 10.

The control unit 14 may consist of an electronic circuit unit that includes a CPU, RAM, ROM, and so on, and is configured to execute computation/control processes for the operation the drive units 13, or in other words, for determining the assisting force applied to the user U. The control unit 14 is configured to read data and application software from the storage device (memory), and perform computation processes under the control of the software.

The walking assistance device 10 thus assists the walking movement of the user U by applying assistance force to the femoral parts of the user U via the pelvic frame 11 and the femoral frames 12, and the required power is supplied by the drive units 13 which are powered by the battery.

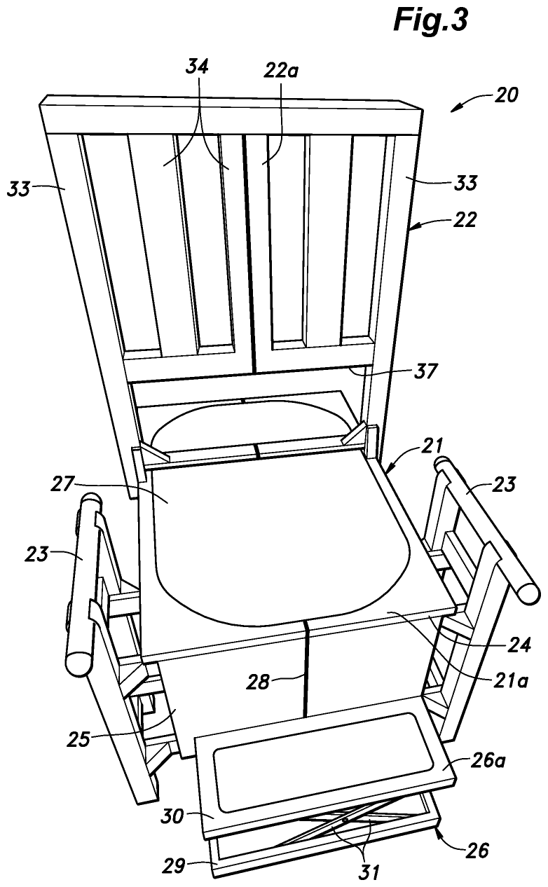

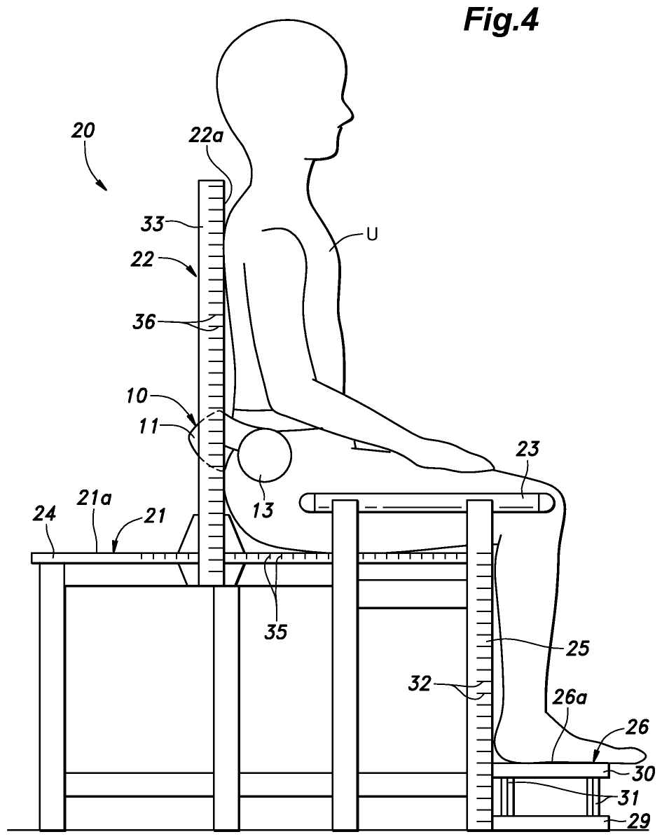

FIG. 3 is a perspective view of the chair 20 shown in FIG. 1, and FIG. 4 is a side view of the chair 20 with the user U sitting thereon. As shown in FIGS. 3 and 4, the chair 20 is made of wood so as to minimize the risk of generating electrostatic noises, and includes a seat 21 defining a horizontal seating surface 21a extending in parallel with the floor surface, a backrest 22 provided so as to be movable in the fore and aft direction relative to the seat 21 and defining a backrest surface 22a extending orthogonally to the seating surface 21a, and a pair of armrests 23 provided on either side of the seat 21.

The seat 21 has a rectangular shape in plan view and somewhat elongated in the fore and aft direction, and includes a seat board 24 defining the seating surface 21a, a front board 25 depending from the front edge of the seat board 24 at a right angle to the seating surface 21a, and a footrest 26 provided in a lower front part of the front board 25. The footrest 26 is provided with a height adjustment mechanism. The seat board 24 is provided with a pressure sensor 27 extending substantially over the entire area of the seating surface 21a except for the peripheral edge thereof. The front board 25 extends laterally substantially by the same width as the seat board 24, and vertically substantially over the entire height of the seat board 24. The front board 25 serves as a crural guide member that ensures that the heels of the user U (the rear ends of the feet of the user U) are positioned directly under the front edge of the seating surface 21a.

A front mark 28 consisting of a line is made on a front part of the upper surface (seating surface 21a) of the seat board 24 and the entire vertical length of the front surface of the front board 25 to indicate a laterally central position. The front mark 28 serves as an indicator for the user U to sit in the center of the chair 20 (the center of the seating surface 21a) with respect to the lateral direction. The front mark 28 also allows the operator to determine if the user U is sitting in the center of the chair 20 (the center of the seating surface 21a) with respect to the lateral direction.

The footrest 26 includes a bottom plate 29 and a top plate 30 arranged in parallel to each other, and a scissor mechanism 31 (X link) connecting the bottom plate 29 and the top plate 30 to each other so that the height of the top plate 30 relative to the bottom plate 29 can be adjusted. By adjusting the height of the footrest surface 26a defined by the upper surface of the top plate 30, the distance between the footrest surface 26a of the footrest 26 and the seating surface 21a can be adjusted. As shown in FIG. 4, a side surface of the front board 25 is provided with a seating surface height scale 32 to allow the distance between the footrest surface 26a and the seating surface 21a to be indicated.

The front board 25 is used for placing the crural parts of the user U seated on the seat 21 along the front surface of the front board 25 or along a vertical plane extending downward from the front edge of the seating surface 21a. By adjusting the height of the footrest surface 26a of the footrest 26 to the seating surface 21a, the femoral parts of the user U seated as described above are caused to extend along the seating surface 21a. By seating the user U on this chair 20 in this manner, the crural parts of the user U can be made orthogonal to the femoral parts of the user U or the knee joint angles is caused to be 90 degrees.

By adjusting the position of the backrest 22 in the fore and aft direction relative to the seating surface 21a, the user can be seated in such a manner that the back and hip of the user U are placed against the backrest surface 22a while the back of each knee of the user U abuts against the front edge of the seating surface 21a. By seating the user U on this chair 20 in this manner, the torso of the user U is caused to be orthogonal to the femoral parts of the user U, and the hip joint angle is caused to be 90 degrees.

The backrest 22 is provided with a pair of vertical posts 33 extending upright along either side of the seat 21, and a backrest board 34 which extending laterally between the posts 33 to define a backrest surface 22a. In the illustrated embodiment, the backrest board 34 consists of a slatted board, but may also be a solid board. As shown in FIG. 4, a side surface of the seat 21 is marked with a seating surface length scale 35 for measuring the distance between the front edge of the seating surface 21a and the backrest surface 22a, with the zero point thereof located at the front edge of the seating surface 21a. A side surface of the backrest 22 is marked with a backrest height scale 36 for measuring the distance of an object (such as the pelvic frame 11 or the inertial measurement sensor 2) from the seating surface 21a with the zero point thereof located at the seating surface 21a.

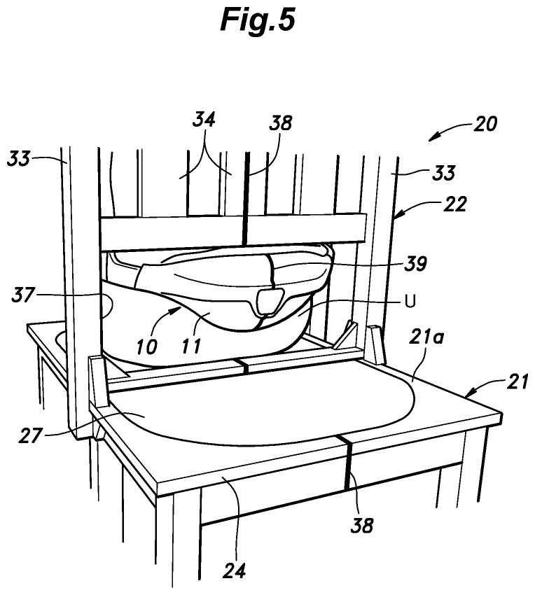

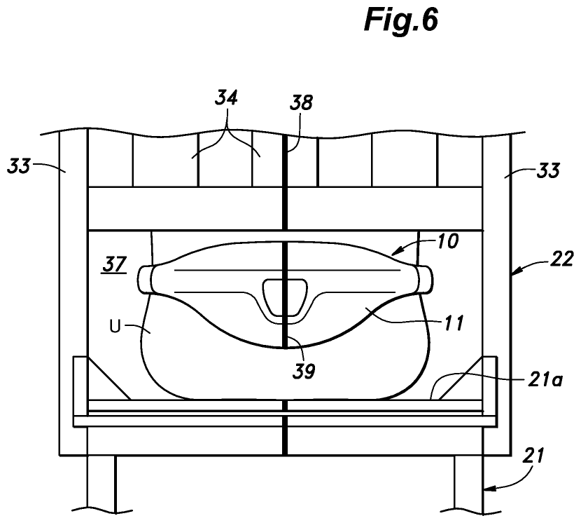

FIG. 5 is a fragmentary perspective view of the chair 20 as viewed from the rear in the state shown in FIG. 4, and FIG. 6 is a fragmentary rear view showing the chair 20 in the state shown in FIG. 4. As shown in FIG. 5 and FIG. 6, the backrest board 34 extends between the posts 33, but there is a gap between the lower edge of the backrest board 34 and the seating surface 21a so that a receiving opening 37 is defined in a lower part of the backrest 22. The receiving opening 37 is dimensioned so as to receive the part of the walking assistance device 10 projecting rearward from the lower back of the user U. Thus, although a part of the walking assistance device 10 projects rearward from the lower back of the user U, owing to the presence of the receiving opening 37, the user U wearing the walking assistance device 10 can sit on the seat 21 with the lower back of the user U placed closely against the backrest 22 because the part of the walking assistance device 10 projecting rearward is received in the receiving opening 37.

A rear mark 38 consisting of a line extends in the rear end surface of the seat 21, a rear part of the seating surface 21a, a cross piece extending laterally between the lower parts of the posts 33, and the rear surface of the backrest 22, to indicate the center with respect to the lateral direction. The rear mark 38 allows the operator to determine if the user U is seated in a laterally central part of the seat 21 by viewing from the rear.

On the rear face of the pelvic frame 11 of the walking assistance device 10 is made a device-side mark 39 consisting of a line extending in the vertical direction at the center with respect to the lateral direction. Thus, the operator can accurately determine if the user U wearing the walking assistance device 10 is sitting at the center of the seating surface 21a with respect to the lateral direction by aligning the device-side mark 39 with the rear mark 38.

The user U is thus seated on the chair 20 in the standard posture in which the torso and the crural parts are parallel to each other, and the femoral parts are orthogonal to the torso and the crural parts. The measurement device 4 calibrates the inertial measurement sensors 2 when the user U is in this standard posture.

FIG. 7 is a block diagram showing the structure of the measurement device 4. The measurement device 4 includes a calibration unit 41 which is configured to calibrate the inertial measurement sensors 2 in response to the command signal from the input operation panel 5. The measurement device 4 further includes a slope coefficient computing unit 43 for computing a slope coefficient β (which is a correction coefficient for the slope of the linear model output of each inertial measurement unit 2) according to the data signal from an optical motion capturing unit 42 and the sensor signals received from the inertial measurement sensors 2 via the wireless communication device 3, a movement measurement unit 44 for measuring the movement of the user U according to the sensor signals received from the inertial measurement sensors 2 via the wireless communication device 3 and the slope coefficient β, and a lateral center determination unit 45 for determining if the user U is seated in a laterally central part of the seating surface 21a according to the output from the surface pressure sensor 27.

The lateral center determination unit 45 determines that the user U is seated in the laterally central part of the seating surface 21a if the surface pressure on the left hand side is equal to the surface pressure of the right hand side within a prescribed tolerance range. When it is determined that the user U is seated in the laterally central part of the seating surface 21a, the lateral center determination unit 45 causes the speaker 7 to generate a corresponding acoustic indication to indicate an acceptable result.

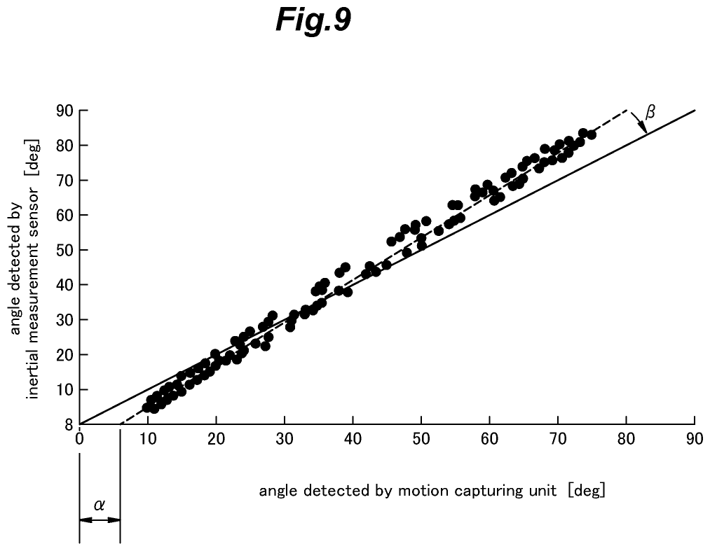

When the acoustic indication is made from the speaker 7 to indicate that the user U is properly seated, the operator then enters a command to initiate the calibration process from the input operation panel 5. Upon receiving this command, the calibration unit 41 starts the calibration of the inertial measurement sensors 2. More specifically, the calibration unit 41 acquires the output value (three-axis acceleration and three-axis angular velocity) of each inertial measurement sensor 2 attached to the corresponding part of the body of the user U who is in the standard posture as zero. In other words, the offset α show in FIG. 9 is eliminated.

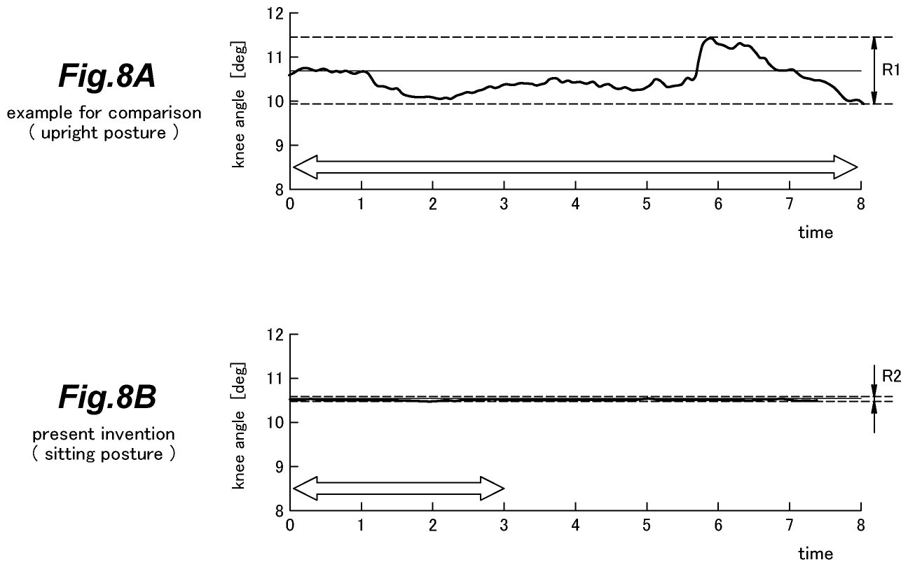

FIGS. 8A and 8B are time charts of the knee angles in the example for comparison, and in the present embodiment, respectively. The example for comparison of FIG. 8A shows the knee angle of the user U suffering from a posture or movement impairment standing in upright posture. FIG. 8B shows the knee angle of the user U suffering from a posture or movement impairment taking the standard posture. When the user U is standing upright, the knee angle fluctuated over time as shown in FIG. 8A. The variation in the knee angle was about 1.5 degrees. When the user U was sitting in the standard posture, the knee angle was more stable, and the variation in the knee angle was only about 0.1 degrees.

It can be appreciated that the calibration method based on the standard posture of the user U allows the calibration of the inertial measurement sensors 2 to be performed in a highly stable manner.

Each inertial measurement sensor 2 outputs a detection value proportional to the three-axis acceleration and the three-axis angular velocity. As well known in the art, some variations in the properties of the inertial measurement sensors 2 are inevitable, and the different inertial measurement sensors 2 may produce different values for the same acceleration or angular velocity. FIG. 9 is a graph showing the correlation between the detected angle values for a same angular movement of the user U as detected by the inertial measurement sensor 2, and as detected by the optical motion capturing unit 42. The output of the inertial measurement sensor 2 representing the angular velocity is integrated so as to obtain the angle value. The output of the inertial measurement sensor 2 can be considered to be based on a linear model so that the deviation from the actual angle value increases linearly with an increase in the actual angle value as shown in FIG. 9.

Based on the assumption that the angle detected by the optical motion capturing unit 42 is accurate, the slope coefficient computing unit 43 computes the slope coefficient β that is required to correct the output value of the inertial measurement sensor 2. More specifically, the slope coefficient computing unit 43 computes the slope coefficient β by dividing the slope of the output of the optical motion capturing unit 42 by the slope of the output of the inertial measurement sensor 2. The computed slope coefficient β is stored in the storage device of the measurement device 4 in association with each particular inertial measurement sensor 2.

The optical motion capturing unit 42 may be either incorporated in the measurement device 4 or constructed as a separate unit.

The movement measurement unit 44 corrects the value obtained from the sensor signal from each inertial measurement sensor 2 by multiplying the slope coefficient 13 thereto when measuring the movement of the user U. Furthermore, the movement measurement unit 44 calculates the velocity and the angle representing the movement of the user U by integrating the values (acceleration and angular velocity), and calculates the position by integrating the velocity. The movement measurement unit 44 can also compute the angular acceleration by differentiating the angular velocity. The movement measurement unit 44 may be configured to display at least one of these values indicating the measured movement of the user U on the display unit 6.

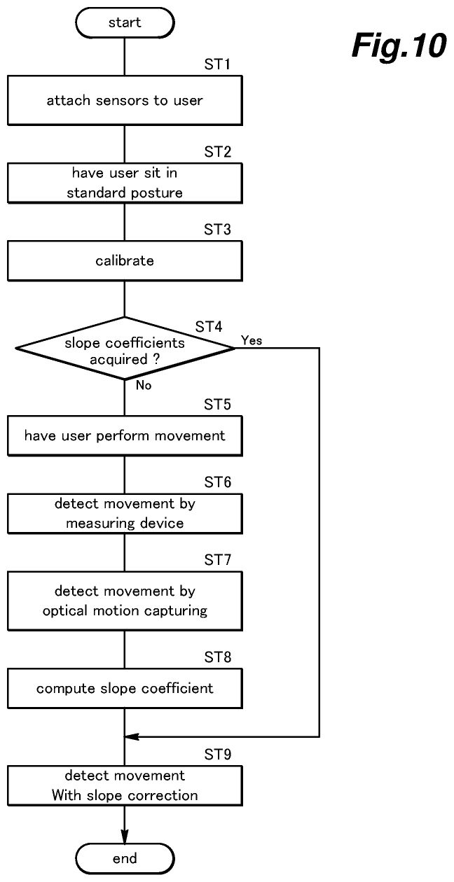

The calibration method of the illustrated embodiment is described in the following with reference to the flowchart shown in FIG. 10. The operator attaches an inertial measurement sensor 2 to each of the torso, femoral parts and crural parts of the user U (step ST1). The operator instructs the user U to sit on the chair 20 in the standard posture (step ST2). Note that steps ST1 and ST2 may be reversed if desired. Once the user U is seated on the chair 20 in the standard posture, and the center determination unit 45 indicates that the user U is properly seated on the chair 20 with the acoustic notification, the operator operates the input operation panel 5 to command the measurement device 4 to initiate the calibration process for the inertial measurement sensors (step ST3). Upon completion of the calibration process, it is determined if the measurement device 4 has acquired the slope coefficient β for each and every inertial measurement sensor 2 (step ST4). The determination may be performed by the measurement device 4 on its own, or may be performed by the operator who operates the input operation panel 5 according to the information displayed on the display unit 6. When the slope coefficient β is acquired for each and every inertial measurement sensor 2 (step ST4; Yes), the process proceeds to step ST9.

When it is determined that the slope coefficient β for at least one of the inertial measurement sensors 2 is not acquired (step ST4; No), the operator causes the user U to perform a walking movement and a prescribed movement for calibration (step ST5). The operator operates the measurement device 4 so as to detect this movement with the measurement device 4 (step ST6), and operates the optical motion capturing unit 42 so as to detect this movement with the optical motion capturing unit 42 (step ST7) at the same time. Thereafter, the measurement device 4 computes the slope coefficient β based on the values measured from the movement of the user U by using the optical motion capturing unit 42 and by using the inertial measurement sensor 2 at the same time (step ST8). The slope coefficient β is then stored in the storage device of the measurement device 4 in association with the particular inertial measurement sensor 2. Thereafter, the operator instructs the user U to perform a movement such as a walking movement so that the measurement device 4 measures the movement with proper slope correction (step ST9).

In step ST9, the operator instructs the user U to walk without wearing the walking assistance device 10, and then to walk wearing the walking assistance device 10. Measurement of the movement of the user U is made in the both cases, and the difference caused by the walking assistance device 10 is evaluated.

As described above, in the calibration method according to the present embodiment, the plurality of inertial measurement sensors 2 are attached to the torso, femoral parts, and crural parts of the user U, respectively (step ST1), and the user U is seated with the standard posture (Step ST2). The calibration of the inertial measurement sensors 2 is performed based on the output of the inertial measurement sensors 2 while the user U is seated with the standard posture (step ST3). This may be referred to as zero error calibration. Therefore, even for a patient with an ailment such as cerebral palsy who may have a great difficulty in standing erect and maintaining an upright posture, the calibration process can be performed accurately while the patient is sitting in the standard posture without experiencing any difficulty or discomfort. This improves the accuracy of the measurement of the movement of the patient.

Furthermore, the calibration method according to the present embodiment further includes the step of measuring the movement of the user U by using the motion capturing unit 42 at the same time as measuring the movement of the user U by using the inertial measurement sensors 2 (step ST7), and correcting the slope of the linear model of the output each inertial measurement sensor 2 according to the movement detected by the motion capturing unit 42 (step ST8 and step ST9). This may be referred to as span error calibration. Therefore, any variations in the properties of the inertial measurement sensors 2 (the slope of the linear model) can be properly compensated, and highly precise measurement of the movement of the user U becomes possible.

The chair 20 according to the present embodiment comprises, as shown in FIGS. 3 and 4, the seat 21 which is adjustable so that the distance between the footrest surface 26a and the seating surface 21a can be adapted to the user U, the backrest 22 configured to be movable in the fore and aft direction, and the front board 25 having the function to guide the crural parts of the user U such that the heels of the user U are positioned directly under the front edge of the seating surface 21a. Thereby, the standard posture of the user U can be ensured with ease. In the standard posture, the femoral parts of the user U extend horizontally along the seating surface 21a, and the crural parts of the user extend vertically along the front board 25. Also, the backs of the knees of the user U are adjacent to the front edge of the seating surface 21a, and the torso of the user U is held upright along the backrest surface 22a of the backrest 22. In particular, even when the user U is suffering from movement or posture impairment, the user U is enabled to take and maintain the standard posture that is required for the calibration process to take place without any difficulty. Also, the burden on the user U at the time of calibration can be minimized.

As shown in FIG. 1, the walking movement measurement system 1 according to the present embodiment includes the inertial measurement sensors 2 attached to the torso, femoral parts and crural parts of the user U, and the measurement device 4 configured to measure the movement of the torso, femoral parts and crural parts of the user U when the user U is wearing or not wearing the walking assistance device 10. The inertial measurement sensors 2 can be calibrated at a high accuracy because the user is seated in the standard posture which is effortless and comfortable to most people. Based on the outputs of these inertial measurement sensors 2, the movement of the user U can be accurately measured such as when the user U is assisted the walking assistance device 10.

As shown in FIGS. 7 and 10, the output of each inertial measurement sensor 2 is corrected by calibrating the slope of the linear model of the inertial measurement sensor 2 based on the output from the optical motion capturing unit 42 so that the variations in the properties of the inertial measurement sensors 2 are properly corrected, and the movement of the user U can be measured at a high precision.

As shown in FIGS. 1 and 3, the control unit 14 of the walking assistance device 10 is provided on the lower back of the user U, and the inertial measurement sensor 2 attached to the torso of the user U is located on the front side of the user U, the inertial measurement sensor 2 is prevented from receiving electromagnetic interferences from the control unit 14.

The chair 20 according to the present embodiment comprises, as shown in FIGS. 3 and 4, the seat 21 which is adjustable so that the distance between the footrest surface 26a and the seating surface 21a can be adapted to the user U, the backrest 22 configured to be movable in the fore and aft direction, and the front board 25 having the function to guide the crural parts of the user U such that the heels of the user U are directly under the front edge of the seating surface 21a. The walking movement measurement system 1 according to the present embodiment includes, as shown in FIGS. 1 and 7, an input operation panel 5 that accepts an input or command to initiate the calibration of the inertial measurement sensors 2. Thus, at the time of the initial calibration, the user U is seated in the standard posture so that the femoral parts of the user U extend horizontally along the seating surface 21a, and the crural parts of the user extend vertically along the front board 25. Also, the backs of the knees of the user U are adjacent to the front edge of the seating surface 21a, and the torso of the user U is held upright along the backrest surface 22a of the backrest 22. By starting the calibration process while the user U is in the standard posture, the inertial measurement sensors 2 can be calibrate at a high precision by using a highly simple arrangement.

As shown in FIGS. 5 and 6, the backrest 22 of the chair 20 is provided with the receiving opening 37 dimensioned and positioned so as to receive a rear end part of the pelvic frame 11 of the walking assistance device 10 and the rear mark 38 drawn vertically in the parts of the backrest 22 located above and below the receiving opening 37 to indicate the laterally central part of the backrest 22. The device-side mark 39 consisting of a vertically extending line is made on the rear side of the pelvic frame 11 of the walking assistance device 10 to indicate the laterally central line of the pelvic frame 11. Therefore, when the user U sits on the chair 20 with the standard posture, the pelvic frame 11 of the walking assistance device 10 does not prevent the user U from resting the back of the user U against the backrest surface 22a of the backrest 22 because the rearwardly protruding part of the pelvic frame 11 is received in the receiving opening 37. Furthermore, the pelvic frame 11 may even be placed on the user U while the user U is seated on the chair 20 by accessing the pelvic part of the user U front the rear via the receiving opening 37. By placing the walking assistance device 10 while the user U is seated on the chair 20, the burden on the user U when placing the walking assistance device 10 on the user U can be minimized. The centering of the user U on the chair 20 is facilitated by aligning the rear mark 38 with the device-side mark 39.

As shown in FIG. 2, the seat 21 is provided with the surface pressure sensor 27 that detects the surface pressure of the seating surface 21a, and the measurement device 4 is provided with the lateral center determination unit 45 (FIG. 7) configured to determine if the gravitational center of the user U seated on the seat 21 is within a prescribed central region according to the output from the surface pressure sensor 27. Therefore, it can be easily verified that the user U is sitting on the center of the seat 21 before starting the calibration process.

The measurement device 4 is provided with the speaker 7 serving as a notification means for notifying that the user U is properly seated on the seat 21 according to the output from the lateral center determination unit 45. Therefore, the operator can easily recognize that the user U is properly seated before starting the calibration process.

Although the present invention has been described in terms of a specific embodiment, the present invention is not limited by such an embodiment, and can be modified in various ways without departing from the spirit of the present invention. For example, the specific configuration or arrangement of each member or portion, the number, the angle, the procedure, and the like can be appropriately changed without departing from the scope of the present invention. On the other hand, not all of the components shown in the above embodiment are necessarily essential, and can be selected and substituted as required.

1. A calibration method, comprising:
attaching an inertial measurement sensor to each of a torso, a femoral part and a crural part of a user for measuring a movement of the user, each inertial measurement sensor being configured to measure a three-axis acceleration and a three-axis angular velocity;
having the user sit on a chair in a standard posture in which the torso and the crural part of the user are substantially parallel to each other, and the femoral part is substantially orthogonal to the torso and the crural part; and
calibrating the inertial measurement sensors by using outputs of the inertial measurement sensors when the user is in the standard posture as reference values.

2. The calibration method according to claim 1, further comprising detecting the movement of the user to whom the inertial measurement sensors are attached by using an optical motion capturing unit, and correcting a slope of a linear model of an output of each inertial measurement sensor according to the movement of the user detected by the optical motion capturing unit.

3. A chair for use in the calibration method according to claim 1, the chair including
a seat configured to be adjustable in height as measured from a footrest surface to a seating surface of the seat so that the femoral part of the user extends along the seating surface,
a backrest configured to be movable in a fore and aft direction relative to the seat so that a back of a knee of the user adjoins a front edge of the seating surface, and a back of the user extends along a backrest surface of the backrest, and
a crural guide member configured to guide the crural part of the user so that a heel of the user is positioned directly under the front edge of the seating surface.

4. A walking movement measurement system, comprising:
a plurality of inertial measurement sensors attached to a torso, a femoral part and a crural part of a user, respectively, for measuring a movement of the user, each inertial measurement sensor being configured to measure a three-axis acceleration and a three-axis angular velocity;
a walking assistance device including a pelvic frame configured to be worn by a pelvic part of the user, a leg frame configured to be worn by a leg part of the user, and a power unit for driving the leg frame relative to the pelvic frame so as to assist a walking movement of the user; and
a measurement device configured to measure movements of the torso, the femoral part and the crural part of the user according to outputs of the inertial measurement sensors when the walking assistance device is assisting the walking movement of the user;
the measurement device being configured to calibrate the inertial measurement sensors by using, as reference values, the outputs of the inertial measurement sensors when the user is in a standard posture in which the torso and the crural part of the user are substantially parallel to each other, and the femoral part is substantially orthogonal to the torso and the crural part.

5. The walking movement measurement system according to claim 4, wherein the measurement device is configured to detect the movement of the user by using an optical motion capturing unit, and correct a slope of a linear model of an output of each inertial measurement sensor according to the movement of the user detected by the optical motion capturing unit.

6. The walking movement measurement system according to claim 4, wherein the walking assistance device is provided with a control unit for controlling a drive force of the power unit, and the control unit is positioned on a back side of the user while the inertial measurement sensor attached to the torso of the user is positioned on a front side of the torso of the user.

7. The walking movement measurement system according to claim 4, further comprising
a chair including a seat configured to be adjustable in height as measured from a footrest surface to a seating surface of the seat, a backrest configured to be movable in a fore and aft direction relative to the seat, and a crural guide member configured to guide the crural part of the user so that a heel of the user is positioned directly under a front edge of the seating surface, and
an input operation unit for accepting an operation to cause the measurement device to start a calibration process of the inertial measurement sensors.

8. The walking movement measurement system according to claim 7, wherein the backrest of the chair is provided with a receiving opening configured to receive a part of the pelvic frame of the walking assistance device, and a chair-side marking provided on a part of the backrest surrounding the receiving opening, and the pelvic frame of the walking assistance device is provided with a device-side marking laterally corresponding to the chair-side marking.

9. The walking movement measurement system according to claim 7, wherein the seat is provided with a pressure sensor for detecting a pressure applied to the seating surface, and the measurement device is provided with a lateral center determining unit configured to determine if a lateral gravitational center of the user is located in a laterally central region of the seat according to an output from the pressure sensor obtained when the user sits on the seat with the standard posture.

10. The walking movement measurement system according to claim 9, wherein the measurement device further comprises a notification unit for notifying an acceptable result when the lateral center determining unit has determined that the lateral gravitational center of the user is located in the laterally central region of the seat.
